(19) United States
(12) Patent Application Publication
(10) Pub. No.: US 2024/0338605 A1
(43) Pub. Date: Oct. 10, 2024

(54) MACHINE LEARNING APPARATUS, MACHINE LEARNING METHOD, AND COMPUTER READABLE NON-TRANSITORY RECORDING MEDIUM STORING MACHINE LEARNING PROGRAM

(71) Applicant: JVCKENWOOD Corporation, Yokohama-shi (JP)

(72) Inventor: Shingo KIDA, Yokohama-shi (JP)

(21) Appl. No.: 18/746,109

(22) Filed: Jun. 18, 2024

Related U.S. Application Data
(63) Continuation of application No. PCT/JP2022/032423, filed on Aug. 29, 2022.

(30) Foreign Application Priority Data
Dec. 23, 2021 (JP) 2021-209556

(51) Int. Cl. G06N 20/00

(52) U.S. Cl. CPC G06N 20/00

(57) ABSTRACT

A machine learning apparatus that continually learns a novel class with fewer samples than a base class is provided. A base class feature extraction unit extracts a feature vector of the base class. A novel class feature extraction unit extracts a feature vector of the novel class. A merged feature calculation unit merges the feature vector of the base class and the feature vector of the novel class to calculate a merged feature vector that merges the base class and the novel class. A learning unit classifies, on a projected space, a query sample of a query set based on a distance between a position of the merged feature vector of the query sample of the query set and a position of a classification weight vector of each class, and learns a classification weight vector of the novel class to minimize a loss incurred in classification.

### CROSS REFERENCE TO RELATED APPLICATION

This application is a continuation of application No. PCT/JP2022/032423, filed on Aug. 29, 2022, and claims the benefit of priority from the prior Japanese Patent Application No. 2021-209556, filed on Dec. 23, 2021, the entire content of which is incorporated herein by reference.

### BACKGROUND

### 1. Technical Field

The present disclosure relates to machine learning technologies.

### 2. Description of the Related Art

Human beings can learn new knowledge through experiences over a long period of time and can maintain old knowledge without forgetting it. Meanwhile, the knowledge of a convolutional neutral network (CNN) depends on the data set used in learning. To adapt to a change in data distribution, it is necessary to re-learn CNN parameters in response to the entirety of the data set. In CNN, the precision estimation for old tasks will be decreased as new tasks are learned. Thus, catastrophic forgetting cannot be avoided in CNN. Namely, the result of learning old tasks is forgotten as new tasks are being learned in continual learning.

Incremental learning or continual learning is proposed as a scheme to avoid catastrophic forgetting. Continual learning is a learning method that improves a current trained model to learn new tasks and new data as they occur, instead of training the model from scratch.

On the other hand, new tasks often have only a limited number of sample data items available. Therefore, few-shot learning has been proposed as a method to efficiently learn from a small amount of training data. In few-shot learning, instead of re-learning previously learned parameters, a novel task is learned by using a small number of additional parameters.

A method called incremental few-shot learning (IFSL) has been proposed, which combines continual learning, where a novel class is learned without catastrophic forgetting of the result of learning the base class, and few-shot learning, where a novel class with fewer examples as compared to the base class is learned (Non Patent Literature 1). In incremental few-shot learning, the base class can be learned from a large-scale data set, while the novel class can be learned from a small number of sample data items.

Moreover, a method has been proposed to improve the classification accuracy of a model through sequential self-distillation in which, starting from the 0th generation model pretrained on a base class, the kth generation model with the same structure as the (k-1) th generation model but with initialized weights is prepared, and the weights of the kth generation model are trained to produce an output similar to the soft label output (probability of the class to be classified) of the (k-1) th generation model (Non Patent Literature 2).
[Non Patent Literature 1]
Yoon, S. W., Kim, D. Y., Seo, J., & Moon, J. (2020 November). XtarNet: Learning to extract task-adaptive representation for incremental few-shot learning. In International Conference on Machine Learning (pp. 10852-10860). PMLR.
[Non Patent Literature 2]
Tian, Y., Wang, Y., Krishnan, D., Tenenbaum, J. B., & Isola, P. (2020). Rethinking few-shot image classification: a good embedding is all you need?. In Computer Vision-ECCV 2020: 16th European Conference, Glasgow, UK, Aug. 23-28, 2020, Proceedings, Part XIV 16 (pp. 266-282). Springer International Publishing.

XtarNet described in Non Patent Literature 1 is an example of incremental few-shot learning method. XtarNet learns to extract a task-adaptive representation (TAR) in incremental few-shot learning. There has been a problem in that there are multiple modules that need to be trained in a meta-learning process for extraction, which makes it difficult for the learning process to converge.

### SUMMARY

A machine learning apparatus according to an embodiment of the present disclosure is a machine learning apparatus that continually learns a novel class with fewer samples than a base class, including: a base class feature extraction unit that extracts a feature vector of the base class; a novel class feature extraction unit that extracts a feature vector of the novel class; a merged feature calculation unit that merges the feature vector of the base class and the feature vector of the novel class to calculate a merged feature vector that merges the base class and the novel class; and a learning unit that classifies, on a projected space, a query sample of a query set based on a distance between a position of the merged feature vector of the query sample of the query set and a position of a classification weight vector of each class, and learns a classification weight vector of the novel class to minimize a loss incurred in classification. The novel class feature extraction unit is obtained by subjecting the base class feature extraction unit to self-distillation k times (k is a natural number).

Another mode of the embodiment relates to a machine learning method. The method is a machine learning method that continually learns a novel class with fewer samples than a base class, including: extracting a feature vector of the base class by using a base class feature extractor; subjecting the base class feature extractor to self-distillation k times (k is a natural number) to obtain a novel class feature extractor; extracting a feature vector of the novel class by using the novel class feature extractor; merging the feature vector of the base class and the feature vector of the novel class to calculate a merged feature vector that merges the base class and the novel class; and classifying, on a projected space, a query sample of a query set based on a distance between a position of the merged feature vector of the query sample of the query set and a position of a classification weight vector of each class, and learning a classification weight vector of the novel class to minimize a loss incurred in classification.

Optional combinations of the aforementioned constituting elements, and implementations of the embodiments in the form of methods, apparatuses, systems, recording mediums, and computer programs may also be practiced as additional modes of the embodiments.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1A is a diagram illustrating a configuration of a pre-training module;

FIG. 1B is a diagram illustrating a configuration of an incremental few-shot learning module;

FIG. 1C is a diagram illustrating episode-based training;

FIG. 2A is a diagram illustrating a configuration to generate task-specific merged weight vectors for calculating the task adaptive expression from the support set;

FIG. 2B is a diagram illustrating a configuration to calculate a task adaptive representation from the support set and generate a classification weight vector set W based on the task adaptive representation;

FIG. 3 is a diagram illustrating a configuration to calculate the task adaptive expression from the query set, classify the query sample based on the task adaptive expression and the classification weight vector set adjusted for the task, and minimize a loss incurred in classification;

FIG. 4 is a diagram showing a configuration and operation of the machine learning apparatus in the pre-learning phase;

FIG. 5 shows a configuration and operation of the machine learning apparatus in meta learning and test phases; and

FIG. 6 shows a configuration of the machine learning apparatus according to the embodiment of the present disclosure.

### DETAILED DESCRIPTION

The invention will now be described by reference to the preferred embodiments. This does not intend to limit the scope of the present invention, but to exemplify the invention.

First, an outline of incremental few-shot learning by XtarNet will be described. XtarNet learns to extract a task adaptive representation (TAR). First, a backbone network that has been pre-trained on a base class data set is used to obtain a feature of the base class. Next, an additional module that has been meta-trained throughout an episode containing a novel class is used to obtain a feature of the novel class. The merged product of the feature of the base class and the feature of the novel class is called a task-adaptive representation (TAR). The base class and novel class classifier uses this TAR to quickly adapt to a given task and performs a classification task.

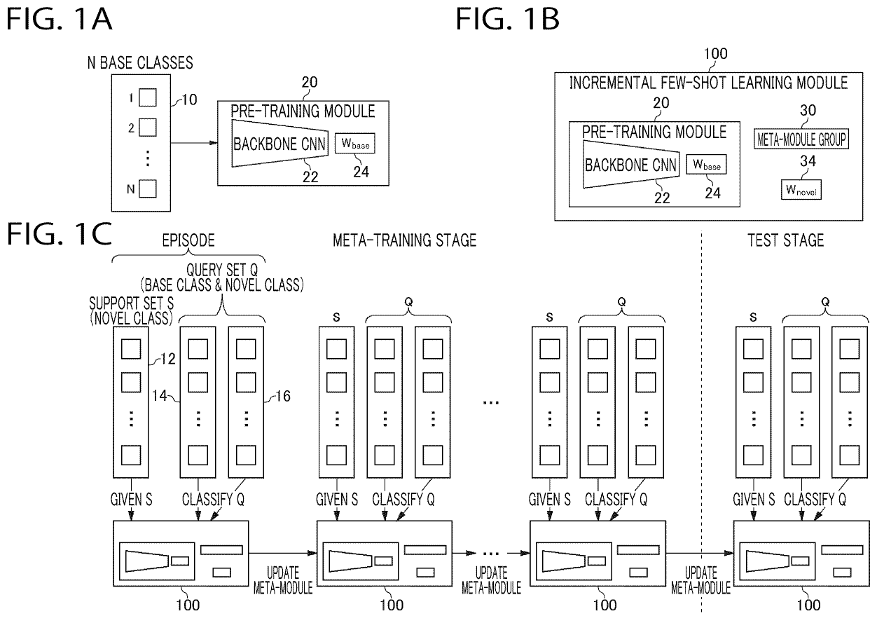

An outline of XtarNet learning procedure will be described with reference to FIGS. 1A-1C.

FIG. 1A is a diagram illustrating a configuration of a pre-training module 20. The pre-training module 20 includes a backbone CNN 22 and a base class classification weight 24.

A base class data set 10 includes N samples. A sample is exemplified by an image but is not limited thereto. The backbone CNN 22 is a convolutional neural network pretrained on the base class data set 10. The base class classification weight 24 is a weight vector W_{base} of the base class classifier and indicates an average feature amount of the sample of the base class data set 10.

In the training stage 1, the backbone CNN 22 is pre-trained on the base class data set 10.

FIG. 1B is a diagram illustrating a configuration of an incremental few-shot learning module 100. The incremental few-shot learning module 100 is derived from adding a meta-module group 30 and a novel class classification weight 34 to the pre-training module 20 of FIG. 1A. The meta-module group 30 includes three multilayer neural networks described later, and is trained on the novel class data set after the initial stage. The number of samples included in the novel class data set is small as compared to the number of samples in the base class data set. The novel class classification weight 34 is a weight vector Wₙₒᵥₑₗ of the novel class classifier and indicates an average feature amount of the samples of the novel class data set.

In the learning stage 2, the meta-module group 30 is trained in episode-based training on the basis of the pre-training module 20.

FIG. 1C is a diagram illustrating episode-based training. The episode-based training includes a meta-training stage and a test stage. The meta-training stage is executed for each episode, and the meta-module group 30 and the novel class classification weight 34 are updated. The test stage performs a classification test by using the meta-module group 30 and the novel class classification weight 34 updated in the meta training stage.

Each episode consists of a support set S and a query set Q. The support set S consists of a novel class data set 12, and the query set Q consists of a base class data set 14 and a novel class data set 16. In the learning stage 2, the query samples of both the base class and the novel class included in the query set Q are classified in each episode, based on the support sample of the given support set S, and the parameter of the meta-module group 30 and the novel class classification weight 34 are updated to minimize a loss incurred in classification.

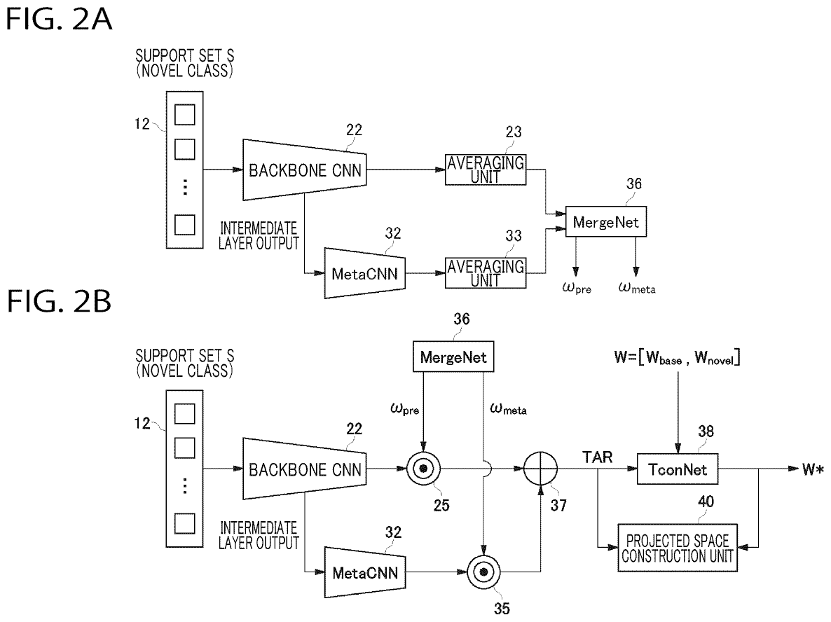

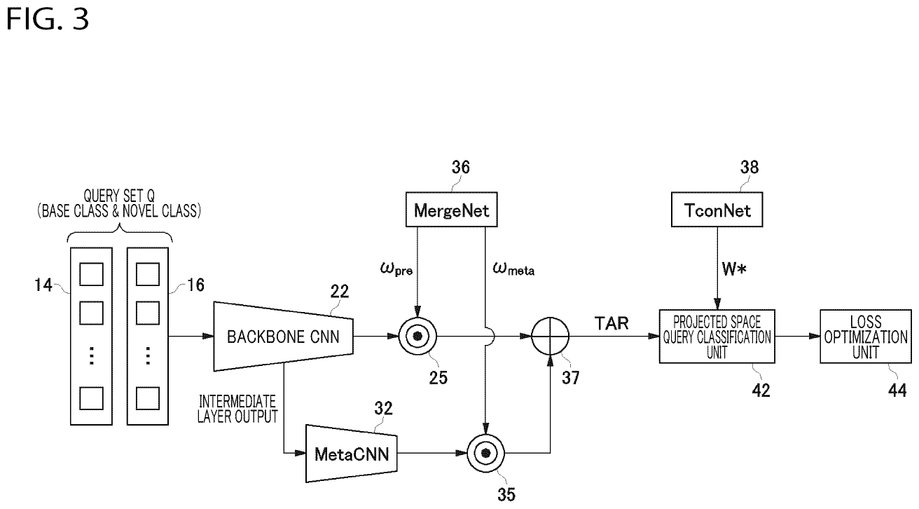

The configuration related to the processing of the support set S in XtarNet will be described with reference to FIGS. 2A and 2B, and the configuration and learning process related to the processing of the query set Q in XtarNet will be described with reference to FIG. 3.

In XtarNet, the following three different meta-trainable modules are used as the meta-module group 30 in addition to the backbone CNN 22:
(1) MetaCNN: A neural network that extracts a feature of a novel class
(2) MergeNet: A neural network that merges the feature of the base class with the feature of the novel class
(3) TconNet: A neural network that adjusts the weight of the classifier

FIG. 2A is a diagram illustrating a configuration to generate task-specific merged weight vectors ωpre and ωmeta for calculating the task adaptive expression TAR from the support set S.

The support set S includes a novel class data set 12. Each support sample of the support set S is input to the backbone CNN22. The backbone CNN 22 processes the support sample, outputs a feature vector of the base class (referred to as “basic feature vector”), and supplies the vector to an averaging unit 23. The averaging unit 23 calculates an average basic feature vector by averaging the basic feature vectors output by the backbone CNN 22 for all support samples, and inputs the vector to a MergeNet 36.

The output of the intermediate layer of the backbone CNN 22 is input to a MetaCNN 32. The MetaCNN 32 processes the output of the intermediate layer of the backbone CNN 22, outputs a novel class feature vector (referred to as “novel feature vector”), and supplies the vector to an averaging unit 33. The averaging unit 33 calculates an average novel feature vector by averaging the novel feature vectors output by the MetaCNN 32 for all support samples, and inputs the vector to the MergeNet 36.

The MergeNet36 processes the average basic feature vector and the average novel feature vector by a neural network and outputs task-specific merged weight vectors ωpre and ωmeta for calculating the task-adaptive representation TAR.

The backbone CNN 22 operates as a basic feature vector extractor f_{θ} that extracts a basic feature vector for an input x and outputs a basic feature vector f_{θ} (x) for the input x. The intermediate layer output of the backbone CNN22 in response to the input x is denoted by ac (x). The MetaCNN 32 operates as a novel feature vector extractor g that extracts a novel feature vector for the intermediate layer output aθ(x), and outputs a novel feature vector g (aθ(x)) for the intermediate layer output aθ(x).

FIG. 2B is a diagram illustrating a configuration to calculate a task adaptive representation TAR from the support set S and generate a classification weight vector set W based on the task adaptive representation TAR.

A vector product arithmetic unit 25 calculates an element-wise product between the basic feature vector f_{θ} (x) output from the backbone CNN 22 in response to each support sample x of the support set S and a merged weight vector ωₚᵣₑ output from the MergeNet 36, and provides the product to a vector sum arithmetic unit 37.

A vector product arithmetic unit 35 calculates an element-wise product between the novel feature vector g (a_{θ}(x)) output from the MetaCNN 32 in response to the intermediate layer output aθ(x) of the backbone CNN 22 in response to each support sample x of the support set S and a merged weight vector ωₘₑₜₐ output from the MergeNet 36, and provides the product to the vector sum arithmetic unit 37.

The vector sum arithmetic unit 37 calculates a vector sum of i) a product between the basic feature vector f_{θ}(x) and the merged weight vector ωₚᵣₑ and ii) a product between the novel feature vector g (a_{θ}(x)) and the merged weight vector ωₘₑₜₐ. The vector sum arithmetic unit 37 outputs the sum as the task adaptive representation TAR of each support sample x of the support set S and provides the TAR to a TconNet 38 and a projected space construction unit 40. The task adaptive representation TAR is a merged feature vector that merges the basic feature vector and the novel feature vector.

Denoting the element-wise product of vectors by x, the formula to calculate the task adaptive expression TAR is as follows.

$$TAR = {ω}_{pre} \times {f}_{θ} ( x ) + {ω}_{meta} \times g ( {a}_{θ} ( x ) )$$

The formula to calculate the task adaptive representation TAR finds a sum of the element-wise product between the merged weight vector and the feature vector. For each support sample of the support set S, the task adaptive expression TAR is calculated.

The TconNet 38 receives an input of the classification weight vector set W= [W_{base}, Wₙₒᵥₑₗ], and outputs a classification weight vector set W* adjusted for the task, using the task adaptive representation TAR of each support sample.

The projected space construction unit 40 constructs a task adaptive projected space M so that an average {Cₖ}, for each class k, of the task adaptive representation TAR of each support sample and W*, adjusted for the task, coincide on the projected space M.

FIG. 3 is a diagram illustrating a configuration to calculate the task adaptive expression TAR from the query set Q, classify the query sample based on the task adaptive expression TAR and the classification weight vector set W* adjusted for the task, and minimize a loss incurred in classification.

The vector product arithmetic unit 25 calculates an element-wise product between the basic feature vector f_{θ} (x) output from the backbone CNN 22 in response to each query sample x of the query set Q and the merged weight vector ωₚᵣₑ output from the MergeNet 36, and provides the product to the vector sum arithmetic unit 37.

The vector product arithmetic unit 35 calculates an element-wise product between the novel feature vector g (a_{θ}(x)) output from the MetaCNN 32 in response to the intermediate layer output a_{θ}(x) of the backbone CNN 22 for each query sample x of the query set Q and the merged weight vector ωₘₑₜₐ output from the MergeNet 36, and provides the product to the vector sum arithmetic unit 37.

The vector sum arithmetic unit 37 calculates a vector sum of i) a product between the basic feature vector f_{θ}(x) and the merged weight vector ωₚᵣₑ and ii) a product between the novel feature vector g (a_{θ}(x)) and the merged weight vector ωₘₑₜₐ. The vector sum arithmetic unit 37 outputs the sum as the task adaptive representation TAR of each query sample x of the query set Q, and provides the TAR to a projected space query classification unit 42.

The classification weight vector set W* adjusted for the task output by the TconNet 38 is input to the projected space query classification unit 42.

The projected space query classification unit 42 calculates a Euclidean distance between the position of the task adaptive representation TAR calculated for each query sample of the query set Q and the position of the average feature vector of the classification target class on the projected space M. The projected space query classification unit 42 classifies the query sample into the closest class. It should be noted that the projected space construction unit 40 operates so that the average position of the classification target class coincides, on the projected space M, with the classification weight vector set W* adjusted for the task.

A loss optimization unit 44 evaluates the loss incurred in classification of the query sample by using a cross-entropy function. The loss optimization unit 44 proceeds with learning so that the result of classification of the query set Q approaches the correct answer and a loss incurred in classification is minimized. As a result, the learnable parameters of the MetaCNN 32, the MergeNet 36, the TconNet 38, and the novel class classification weight Wₙₒᵥₑₗ are updated so that a distance between the position of the task-adapted representation TAR calculated for the query sample and the position of the average feature vector of the classification target class, i.e., the position of the classification weight vector set W* adjusted for the task, becomes smaller.

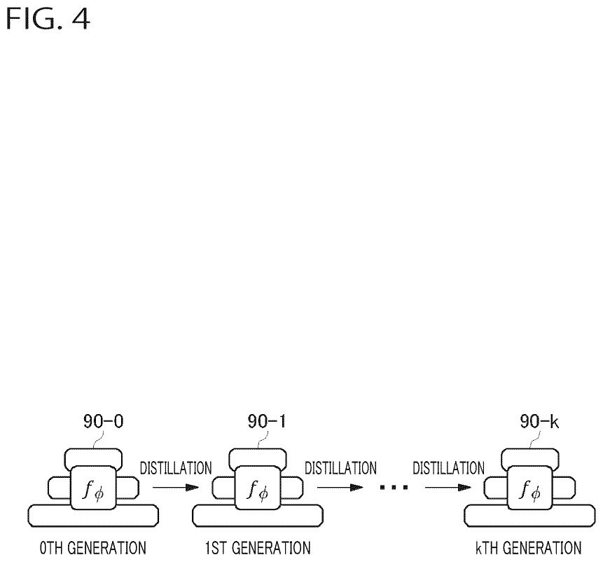

The configuration and operation of the embodiment of the present disclosure will be described with reference to FIGS. 4-6.

FIG. 4 is a diagram illustrating the learning process of the feature extractor in the pre-learning phase. The 1st to the kth generation feature extractors f_{ϕ} (symbols 90-1 to 90-k), which are suitable for identifying a novel class, are generated by repeating self-distillation using the base class data set and using, as a supervisor model, the 0th generation feature extractor f_{ϕ} (symbol 90-0), which is pre-trained on the base class data set and suitable for identifying a base class. For self-distillation, the method described in Non Patent Literature 2 is used.

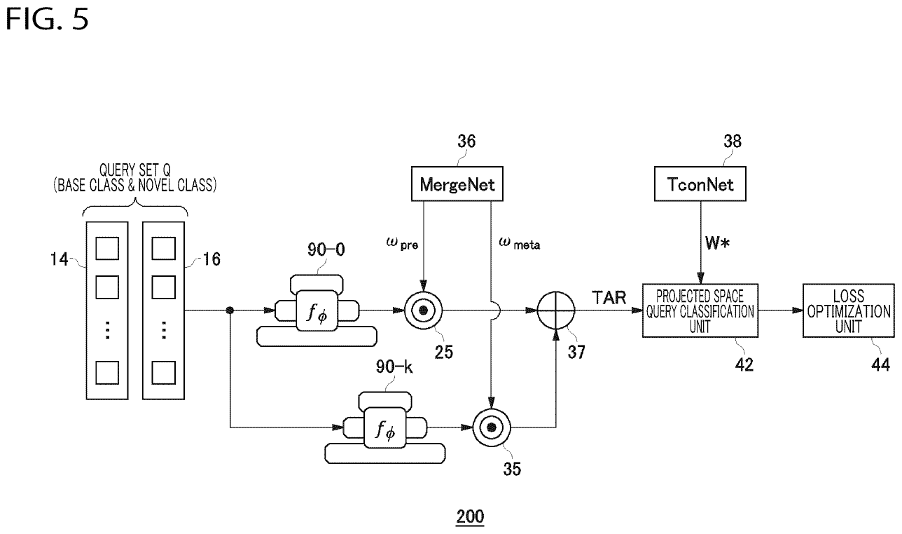

FIG. 5 shows a configuration and operation of the machine learning apparatus in meta learning and test phases. The machine learning apparatus 200 differs from the configuration of XtarNet of FIG. 3 in that it uses the 0th generation feature extractor f_{ϕ} (symbol 90-0) instead of the backbone CNN 22 of FIG. 3, and uses the kth generation feature extractor f_{ϕ} (symbol 90-k) instead of the MetaCNN 32 of FIG. 3. The other aspects of the configuration and operation are the same as those of XtarNet of FIG. 3.

The 0th generation feature extractor f_{ϕ} (symbol 90-0) outputs the basic feature vector f_{θ} (x) in response to each support sample x of the query set Q. The k-generation feature extractor f_{ϕ} (symbol 90-k) outputs the novel feature vector g_{θ}(x) in response to each support sample x of the query set Q.

Of the components constituting the TAR calculator in the related-art XtarNet of FIG. 3, modules that need to be trained in a meta-learning process are the MetaCNN 32 and the MergeNet 36.

In the machine learning apparatus 200 of this embodiment, on the other hand, the 0th generation feature extractor f_{ϕ} extracts the feature of the base class, and the kth generation feature extractor f_{ϕ} extracts the feature of the novel class. The average value of the 1st to the kth generation feature extractors f_{ϕ} may be used instead of the kth generation feature extractor f_{ϕ}. Further, the feature extractor f_{ϕ} of any generation among the 1st to the kth generations may be used instead of the kth generation feature extractor f_{ϕ}. The 0th generation feature extractor f_{ϕ} and the 1st to the kth generation feature extractors f_{ϕ} are defined as pretrained models, and the parameters thereof are fixed in the meta-learning stage. This results in only the MergeNet36 remaining as the module of the machine learning apparatus 200 that needs to be trained in a meta-learning process, which makes it easier for meta-learning to converge.

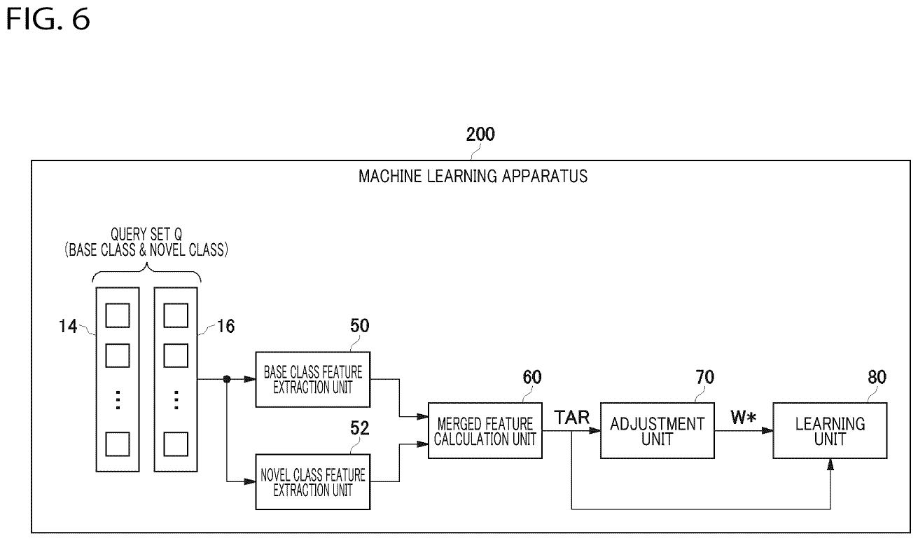

FIG. 6 shows a configuration of the machine learning apparatus 200 according to the embodiment of the present disclosure. A description of the configuration common to that of XtarNet will be omitted as appropriate, and the configuration added to XtarNet will mainly be described.

The machine learning apparatus 200 includes a base class feature extraction unit 50, a novel class feature extraction unit 52, a merged feature calculation unit 60, an adjustment unit 70, and a learning unit 80.

A query set Q consisting of a base class data set 14 and a novel class data set 16 is input to the base class feature extraction unit 50. The base class feature extraction unit 50 is the 0th generation feature extractor f_{ϕ} of FIG. 4. The base class feature extraction unit 50 extracts and outputs the basic feature vector of each query sample of the query set Q.

The novel class feature extraction unit 52 receives a query set Q consisting of the base class data set 14 and the novel class data set 16 as an input. The novel class feature extraction unit 52 outputs an output value of the kth generation feature extractor f_{ϕ} of FIG. 4 or an average value of the output values of the 1st to the kth generation feature extractors f_{ϕ}. The novel class feature extraction unit 52 may output the output value of the feature extractor f_{ϕ} of any generation among the 1st to the kth generations. The novel class feature extraction unit 52 extracts and outputs the novel feature vector of each query sample of the query set Q.

The merged feature calculation unit 60 merges the basic feature vector and the novel feature vector of each query sample to calculate the merged feature vector as the task adaptive representation TAR, and provides the TAR to the adjustment unit 70 and the learning unit 80. The merged feature calculation unit 60 is exemplified by the MergeNet 36.

The adjustment unit 70 calculates the classification weight vector set W* adjusted for the task, using the task adaptive expression TAR of each query sample, and provides the vector set to the learning unit 80. The adjustment unit 70 is exemplified by the TconNet 38.

The learning unit 80 classifies, on the projected space M, the query sample based on a distance between the position of the task adaptive representation TAR of the query sample and the weight of the classifier of each class. The learning unit 80 learns to minimize a loss incurred in classification. The learning unit 80 is exemplified by the projected space query classification unit 42 and the loss optimization unit 44.

The above-described various processes in the machine learning apparatus 200 can of course be implemented by apparatuses that use hardware such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

As described above, there are, in the related-art XtarNet, multiple modules for extracting a task adaptive representation that need to be trained in a meta-learning process, which complicates the learning process and makes it difficult for the loss to converge. According to the machine learning apparatus 200 of the embodiment, on the other hand, the number of modules that need to be trained in a meta-learning process can be reduced by pre-training the feature extractor suitable for identifying a base class and the feature extractor suitable for identifying a novel class during a pre-training phase. Thereby, the loss converges easily, and the learning time can be reduced.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. A machine learning apparatus that continually learns a novel class with fewer samples than a base class, comprising:
a base class feature extraction unit that extracts a feature vector of the base class;
a novel class feature extraction unit that extracts a feature vector of the novel class;
a merged feature calculation unit that merges the feature vector of the base class and the feature vector of the novel class to calculate a merged feature vector that merges the base class and the novel class; and
a learning unit that classifies, on a projected space, a query sample of a query set based on a distance between a position of the merged feature vector of the query sample of the query set and a position of a classification weight vector of each class, and learns a classification weight vector of the novel class to minimize a loss incurred in classification,
wherein the novel class feature extraction unit is obtained by subjecting the base class feature extraction unit to self-distillation k times (k is a natural number).

2. The machine learning apparatus according to claim 1,
wherein the novel class feature extraction unit averages values output by a 1st to a kth generation feature extraction units obtained by subjecting the base class feature extraction unit to self-distillation k times and outputs an average value.

3. A machine learning method that continually learns a novel class with fewer samples than a base class, comprising:
extracting a feature vector of the base class by using a base class feature extractor;
subjecting the base class feature extractor to self-distillation k times (k is a natural number) to obtain a novel class feature extractor;
extracting a feature vector of the novel class by using the novel class feature extractor;
merging the feature vector of the base class and the feature vector of the novel class to calculate a merged feature vector that merges the base class and the novel class; and
classifying, on a projected space, a query sample of a query set based on a distance between a position of the merged feature vector of the query sample of the query set and a position of a classification weight vector of each class, and learning a classification weight vector of the novel class to minimize a loss incurred in classification.

4. A computer readable non-transitory recording medium storing a machine learning program that continually learns a novel class with fewer samples than a base class, the program comprising computer-implemented modules that include:
a module that extracts a feature vector of the base class by using a base class feature extractor;
a module that subjects the base class feature extractor to self-distillation k times (k is a natural number) to obtain a novel class feature extractor;
a module that extracts a feature vector of the novel class by using the novel class feature extractor;
a module that merges the feature vector of the base class and the feature vector of the novel class to calculate a merged feature vector that merges the base class and the novel class; and
a module that classifies, on a projected space, a query sample of a query set based on a distance between a position of the merged feature vector of the query sample of the query set and a position of a classification weight vector of each class, and learns a classification weight vector of the novel class to minimize a loss incurred in classification.
